(19) United States
(12) Patent Application Publication
(10) Pub. No.: US 2010/0299469 A1
(43) Pub. Date: Nov. 25, 2010

(54) ACCESS CONTROL CIRCUIT

(75) Inventor: Hirofumi Fujikawa, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Osaka (JP)

(21) Appl. No.: 12/773,082

(22) Filed: May 4, 2010

(30) Foreign Application Priority Data
May 22, 2009 (JP) 2009-124727

(51) Int. Cl. G06F 13/34

(52) U.S. Cl. 710/244

(57) ABSTRACT

An access control circuit includes a status managing circuit. The status managing circuit accepts one or at least two access requests issued from a plurality of buffer circuits each of which has a priority different from each other. A decoder repeatedly determines whether or not the one or at least two access requests accepted by the status managing circuit include an urgent access request. When a determination result is negative, the decoder acknowledges an access request corresponding to a higher priority out of the one or at least two access requests accepted by the status managing circuit. On the other hand, when the determination result is affirmative, the decoder acknowledges the urgent access request.

### CROSS REFERENCE OF RELATED APPLICATION

The disclosure of Japanese Patent Application No. 2009-124727, which was filed on May 22, 2009, is incorporated herein by reference.

### BACKGROUND OF THE INVENTION

1. Field of the Invention

The present invention relates to an access control circuit. In particular, the present invention relates to an access control circuit which controls an access process performed according to one or at least two access requests issued from a plurality of access requesting circuits each of which has a priority different from each other.

2. Description of the Related Art

According to one example of this type of circuit, upon arbitrating a plurality of access requests, an order of priority of a refresh request is always set lower than that of an input-data writing request. Therefore, the input-data writing request is permitted even during a refresh process is being executed, and as a result, a system failure caused due to lacking of input data, etc., is avoided.

However, in the above-described circuit, data access requests such as an input-data writing request are not issued in parallel from a plurality of request sources, and the orders of priority are not switched among a plurality of parallel data access requests. Thus, when the plurality of data access requests are issued in parallel, it is probable in the conventional technique that a data access process is failed.

### SUMMARY OF THE INVENTION

An access control circuit according to the present invention, comprises: an acceptor which accepts one or at least two data access requests issued from a plurality of access requesting circuits each of which has a priority different from each other; a determiner which repeatedly determines whether or not the one or at least two data access requests accepted by the acceptor include an urgent data-access request; a first acknowledger which acknowledges a data access request corresponding to a higher priority out of the one or at least two data access requests accepted by the acceptor when a determination result of the determiner is negative; and a second acknowledger which acknowledges the urgent data-access request when the determination result of the determiner is affirmative.

Preferably, each of the plurality of access requesting circuits includes a buffer memory which temporarily holds access data and a measurer which measures an extra time period until a vacant capacity of the buffer memory reaches a reference, and the determiner includes a calculator which calculates a level of urgency of each of the one or at least two data access requests by referring to the extra time period measured by the measurer.

More preferably, the one or at least two data access requests accepted by the acceptor are equivalent to a data access request to a memory adopting a burst access system, and the calculator executes a calculating process by further referring to an overhead and a burst length of an access operation performed according to a data access request to be noticed.

Preferably, further comprised is an access processer which executes a data access process performed according to the data access request acknowledged by each of the first acknowledger and the second acknowledger.

Preferably, the determiner further includes a detector which detects an accepting state of the acceptor when the data access process performed by the access processor is interrupted.

Preferably, a data processing device comprises an above-described access control circuit

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a basic configuration of the present invention;

FIG. 2 is a block diagram showing a configuration of one embodiment of the present invention;

FIG. 3 is a block diagram showing one example of a configuration of a buffer circuit applied to the embodiment in FIG. 2;

FIG. 4 is an illustrative view showing one example of a configuration of a register referred to by the embodiment in FIG. 2;

FIG. 5(A) is a waveform chart showing one example of a clock;

FIG. 5(B) is a waveform chart showing one example of an access request outputted from a buffer circuit 14a;

FIG. 5(C) is an illustrative view showing one example of a count value outputted from the buffer circuit 14a;

FIG. 5(D) is a waveform chart showing one example of an access request outputted from a buffer circuit 14b;

FIG. 5(E) is an illustrative view showing one example of a count value outputted from the buffer circuit 14b;

FIG. 5(F) is a waveform chart showing one example of an access request outputted from a buffer circuit 14c;

FIG. 5(G) is an illustrative view showing one example of the count value outputted from the buffer circuit 14c;

FIG. 5(H) is a waveform chart showing one example of an active/non-active state of the buffer circuit 14a;

FIG. 5(I) is a waveform chart showing one example of an active/non-active state of the buffer circuit 14b;

FIG. 5(J) is a waveform chart showing one example of an active/non-active state of the buffer circuit 14c;

FIG. 5(K) is an illustrative view showing one example of memory access states of the buffer circuits 14a to 14c;

FIG. 6 is a flowchart showing one portion of a processing operation of a decoder applied to the embodiment in FIG. 2; and

FIG. 7 is a flowchart showing another portion of the processing operation of the decoder applied to the embodiment in FIG. 2.

### DETAILED DESCRIPTION OF THE PREFERRED EMBODIMENTS

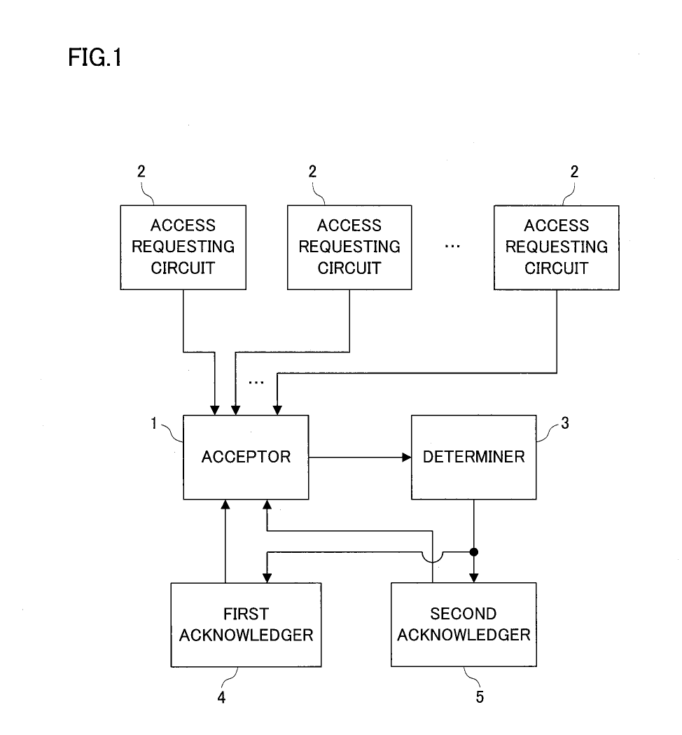

With reference to FIG. 1, an access control circuit of the present invention is basically configured as follows: An acceptor 1 accepts one or at least two data access requests issued from a plurality of access requesting circuits 2, 2, . . . each of which has a priority different from each other. A determiner 3 repeatedly determines whether or not the one or at least two data access requests accepted by the acceptor 1 include an urgent data-access request. When a determination result of the determiner 3 is negative, a first acknowledger 4 acknowledges a data access request corresponding to a higher priority out of the one or at least two data access requests accepted by the acceptor 1. When the determination result of the determiner 3 is affirmative, a second acknowledger 5 acknowledges the urgent data-access request.

Therefore, when the urgent data-access request is accepted, the urgent data-access request is acknowledged regardless of the priority. Thereby, it becomes possible to avoid a failure of a data access process caused due to parallel issuance of a plurality of data access requests.

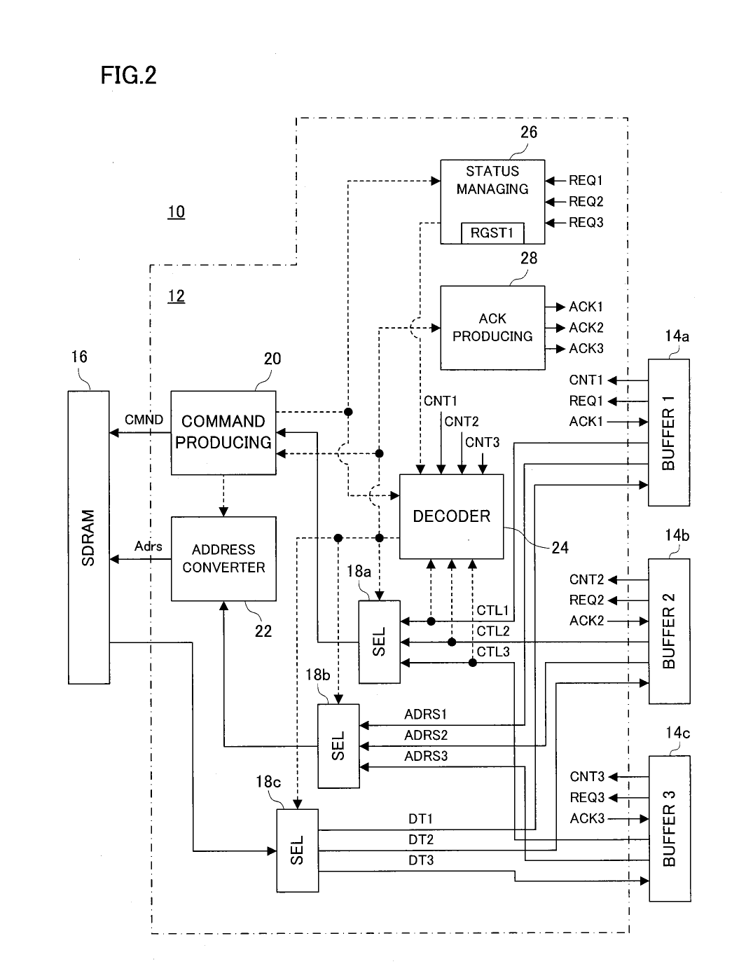

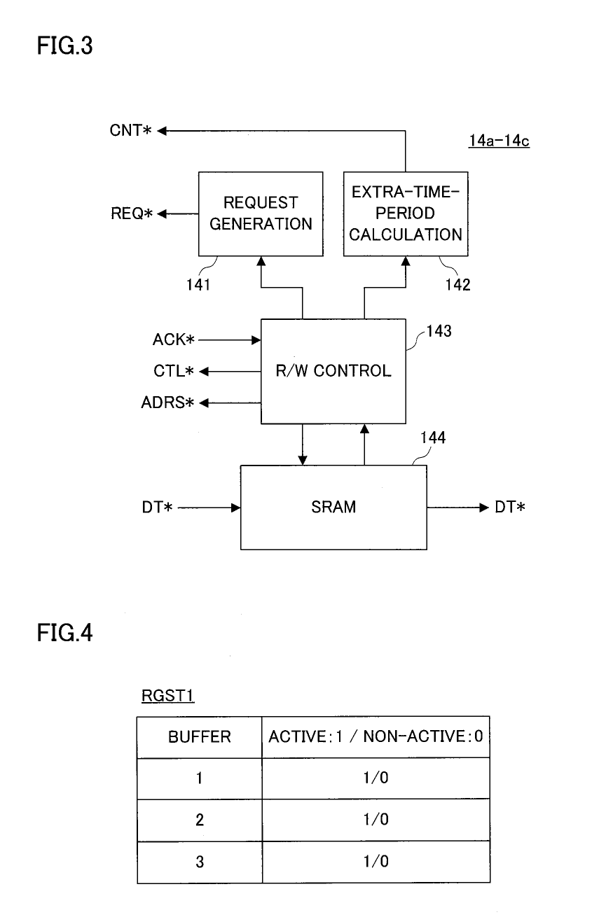

With reference to FIG. 2, a data processing device 10 according to this embodiment comprises: a single memory control circuit 12; a plurality of buffer circuits 14a to 14c; and a DDR-SDRAM 16 that adopts a burst access system. Each of the buffer circuits 14a to 14c is configured as shown in FIG. 3.

In a description that follows, for the sake of simplicity, all the buffer circuits 14a to 14c execute a read access only. Moreover, a burst length for each access is “four words”, and the number of clocks that is needed for each read access is “15”. It is noted that specifically, the number of clocks that is needed for each read access matches a total of the number of clocks equivalent to ½ the burst length and the number of clocks equivalent to an overhead of a burst access.

Moreover, the buffer circuits 14a, 14b, and 14c have identification numbers of “1”, “2”, and “3”, respectively. Also, the buffer circuits 14a to 14c are assigned priorities that are lowered in an order of 14a to 14b to 14c.

Upon the read access, a request generating circuit 141 shown in FIG. 3 issues an access request REQ* (*: the same number as the identification number. The same applies below) toward a status managing circuit 26. Moreover, an R/W control circuit 143 outputs control data CTL* in which an access mode (=read) is written toward a selector 18a, and outputs address information ADRS* in which a head address of an access destination is written, toward a selector 18b.

The status managing circuit 26 updates a setting of a register RGST1 shown in FIG. 4 corresponding to the applied access request REQ*. A writing of a column assigned to an issuance source of the access request REQ* is updated from “0” to “1”, and as a result, the issuance source of the access request REQ* becomes an active state. An access status active state/non-active state) of the buffer circuits 14a to 14c is managed by the register RGST1.

A decoder 24 repeatedly refers to the register RGST1 when the read access is interrupted, and acknowledges any one of the access requests REQ* according to a level of urgency of the access request REQ* and/or the priority of the buffer circuits 14a to 14c. From the decoder 24, the identification number corresponding to the issuance source of the acknowledged access request REQ* is outputted. The outputted identification number is applied to an ACK producing circuit 28, the selectors 18a to 18c, and a command producing circuit 20.

The ACK producing circuit 28 outputs the acknowledgement signal ACK* toward the R/W control circuit 143 (see FIG. 3) of a buffer circuit having the applied identification number. The R/W control circuit 143 recognizes that as a result of the acknowledgement signal ACK* being inputted, the access request of the R/W control circuit 143 is acknowledged, and makes a preparation for inputting of data that is to be subsequently read out.

The selector 18a selects the buffer circuit having the identification number applied from the decoder 24, and applies the control data CTL* from the selected buffer circuit, to the command producing circuit 20. Similarly, the selector 18b selects the buffer circuit having the identification number applied from the decoder 24, and applies the address information ADRS* from the selected buffer circuit, to an address converter 22.

The command producing circuit 20 produces a command CMND corresponding to the control data CTL* applied from the selector 18a, and outputs the produced command CMND toward the DDR-SDRAM 16. The address converter 22 converts an address indicated by the address information ADRS* applied from the selector 18b, into an actual address Adrs of the DDR-SDRAM 16, and outputs the converted actual address Adrs toward the DDR-SDRAM 16. Data DT* equivalent to the desired four words is read out from the DDR-SDRAM 16 by a burst access.

The selector 18c outputs the data DT* read-out from the DDR-SDRAM 16 toward the buffer circuit having the identification number applied from the decoder 24. The data DT* is temporarily written in an SRAM 144 shown in FIG. 3, and then, outputted toward a data processing system not shown.

When reading out the data equivalent to the desired four words is ended, the command producing circuit 20 applies an access ending signal to the decoder 24 and the status managing circuit 26. The decoder 24 stops the output of the identification number in response to the access ending signal. Thereby, the acknowledgement of the access request is canceled. The status managing circuit 26 refers to the access ending signal so as to change the setting to the register RGST1. The writing of a column corresponding to the access request REQ* in which the read access is ended is updated from “1” to “0”, and as a result, the issuance source of the access request REQ* becomes a non-active state.

In association with the level of urgency of the access request REQ*, an extra-time-period calculating circuit 142 shown in FIG. 3 repeatedly calculates an extra time period until a vacant capacity of the SRAM 144 reaches a reference value (=time period until the SRAM 144 is depleted). Data reading-out from the SRAM 144 is executed in synchronization with a clock CLK, and the extra time period decreases also in synchronization with the clock CLK. The extra-time-period calculating circuit 142 outputs, as the extra time period, a count value CNT* decremented in response to the clock CLK.

The decoder 24 subtracts “15” or the number of clocks necessary for each read access, from thus outputted count value CNT*, so as to calculate the level of urgency of the corresponding access request REQ*. Moreover, the decoder 24 determines, as “low”, the level of urgency of the access request REQ* that is noticed when the calculated level of urgency (=subtracted value) exceeds “0”, and determines, as “high”, the level of urgency of the access request REQ* that is noticed when the calculated level of urgency (=subtracted value) is equal to or less than “0”.

When the access request REQ* having a high level of urgency is detected, the decoder 24 acknowledges, as a top priority, this urgent access request. On the other hand, when the urgent access request is not detected, the decoder 24 acknowledges the access request REQ* in an order according to the priority assigned to the buffer circuits 14a to 14c.

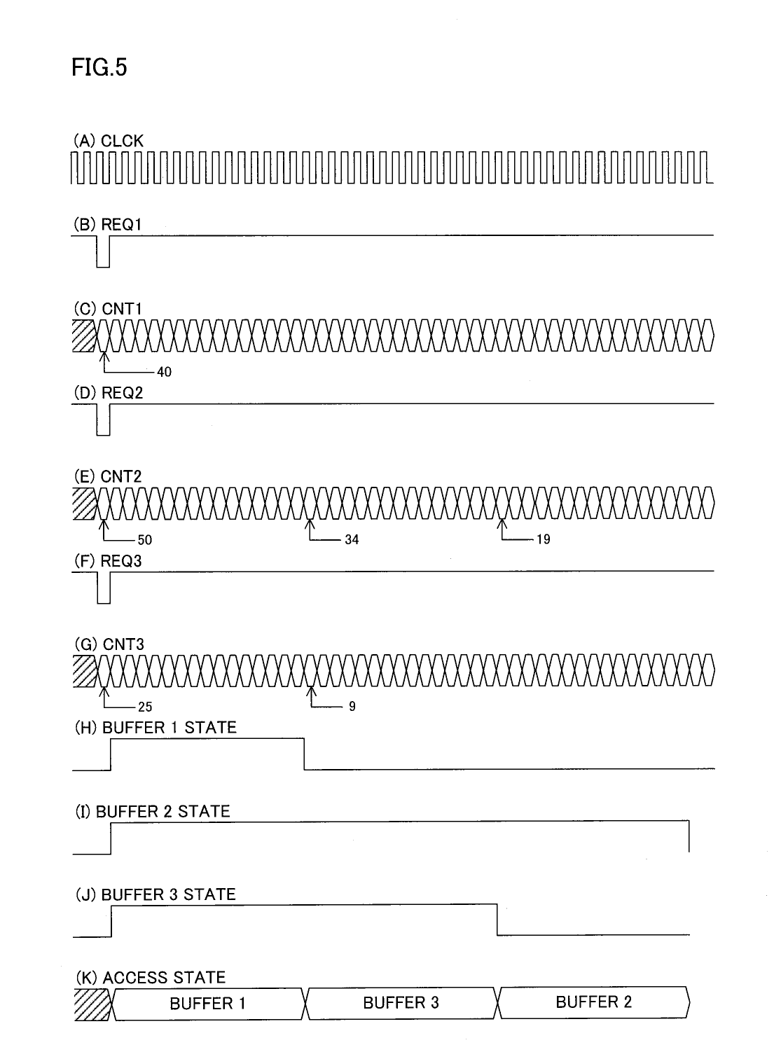

With reference to FIG. 5(A) to FIG. 5(K), when the access requests REQ1, REQ2, and REQ3 are simultaneously issued, the buffer circuits 14a to 14c are simultaneously moved to the active state. At this time, the count values CNT1 to CNT3 indicate “40”, “50”, and “25”, respectively. The level of urgency is updated from “low” to “high” when the count value CNT* is decreased to “15”. Therefore, at this time point, the access request REQ1 is acknowledged, and the read access according to the access request REQ1 is executed.

When the read access according to the access request REQ1 is ended, the buffer circuit 14a is transitioned from the active state to the non-active state. Also, at this time point, the count values CNT2 and CNT3 indicate “34” and “9”, respectively. As a result, the level of urgency of the access request REQ3 is regarded as high, and then, the access request REQ3 is acknowledged first in spite of a fact that the priority of the buffer circuit 14b is higher than that of the buffer circuit 14c.

When the read access according to the access request REQ3 is ended, the buffer circuit 14c is transitioned from the active state to the non-active state, and at the same time, the access request REQ2 is acknowledged. A state of the buffer circuit 14b is transitioned to the non-active state after the read access according to the access request REQ2 is ended.

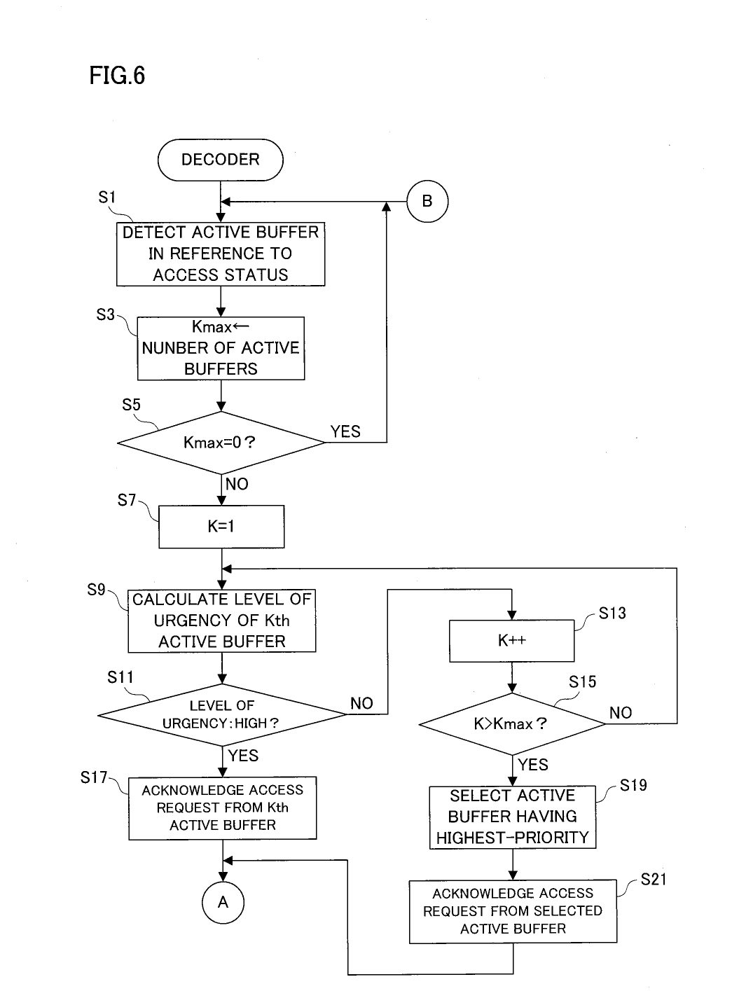

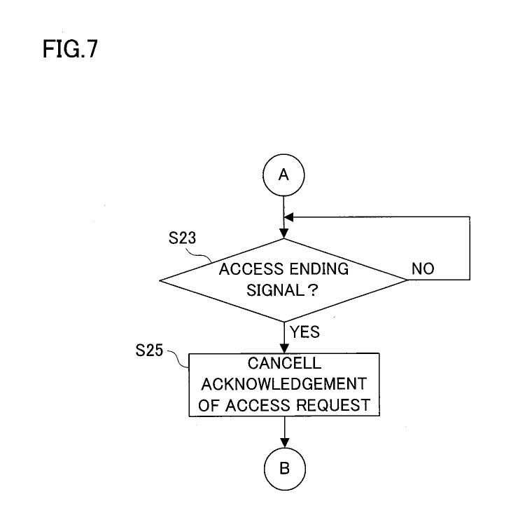

More particularly, the decoder 24 executes acknowledgement control of the access request according to a flowchart shown in FIG. 6 to FIG. 7.

Firstly, in a step S1, the register RGST1 is referred to so as to detect the buffer circuit in an active state. In a step S3, the number of the buffer circuits in an active state is set to a variable Kmax. In a step S5, it is determined whether or not the variable Kmax is “0”, and when YES is determined, the process returns to the step S1 while NO is determined, the process advances to a step S7.

In the step S7, the variable K is set to “1”, and in a step S9, the level of urgency of a K-th buffer circuit in an active state is calculated. In a step S11, it is determined whether or not the calculated level of urgency is high.

When a determination result is YES, the process advances to a step S17 so as to acknowledge an access request from the K-th buffer circuit in an active state. When the determination result is NO, the variable K is incremented in a step S13, and it is determined in a step S15 whether or not the incremented variable K exceeds the variable Kmax. When the variable K is equal to or less than the variable Kmax, the process returns to the step S9, and when the variable K exceeds the variable Kmax, the process advances to a step S19. In the step S19, the buffer circuit having the highest priority is selected from among the buffer circuits in an active state. In a step S21, the access request of the selected buffer circuit is acknowledged.

Upon completion of the process in the step S17 or the step S21, it is determined in a step S23 whether or not the access ending signal is applied from the command producing circuit 20. When the determination result is updated from NO to YES, the acknowledgement of the access request is canceled in a step S25, and then, the process returns to the step S1.

As can be seen from the above-described explanation, the status managing circuit 26 accepts one or at least two access requests issued from a plurality of buffer circuits 14a to 14c each of which has a priority different from each other. The decoder 24 repeatedly determines whether or not the one or at least two access requests accepted by the status managing circuit 26 include the urgent access request (S1 to S15). When the determination result is negative, the decoder 24 acknowledges the access request corresponding to a higher priority out of the one or at least two access requests accepted by the status managing circuit 26 (S19 to S21). On the other hand, when the determination result is affirmative, the decoder 24 acknowledges the urgent access request (S17).

Therefore, when the urgent access request is accepted, the urgent access request is acknowledged regardless of the previously set priority. Thereby, it becomes possible to avoid a failure of the access process caused due to parallel issuance of a plurality of access requests.

It is noted that in this embodiment, a DDR (Double-Data-Rate)-type SDRAM is adopted; however, instead thereof, a conventional SDRAM (SDRAM of which the data transfer speed is half that of the DDR type) may also be optionally adopted.

Also, the memory control circuit according to this embodiment is adapted to a bus system of a digital camera. In the digital camera, a data input circuit from an imaging element or a buffer circuit of a data output circuit to a display device is assigned a higher priority because of a real-time process request. Furthermore, a buffer circuit of an encoding circuit which encodes moving-image data when a moving-image recording instruction is issued is also assigned the higher priority. Therefore, the priority is assigned in an order from the data input circuit to the encoding circuit to the data output circuit, for example.

With this in mind, when the access requests are simultaneously issued from these circuits, the memory control circuit basically acknowledges these access requests according to an order that is based on the priority. However, although the buffer circuits of the data input circuit and the encoding circuit have an extra space, if there occurs an instance where the buffer circuit of the data output circuit does not have the extra space any longer, then the access request from the data output circuit is taken priority over any other access request and processed regardless of the original priority. Thereby, a failure of the bus system is avoided.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An access control circuit, comprising:
an acceptor which accepts one or at least two data access requests issued from a plurality of access requesting circuits each of which has a priority different from each other;
a determiner which repeatedly determines whether or not the one or at least two data access requests accepted by said acceptor include an urgent data-access request;
a first acknowledger which acknowledges a data access request corresponding to a higher priority out of the one or at least two data access requests accepted by said acceptor when a determination result of said determiner is negative; and
a second acknowledger which acknowledges the urgent data-access request when the determination result of said determiner is affirmative.

2. An access control circuit according to claim 1, wherein each of the plurality of access requesting circuits includes a buffer memory which temporarily holds access data and a measurer which measures an extra time period until a vacant capacity of said buffer memory reaches a reference, and said determiner includes a calculator which calculates a level of urgency of each of the one or at least two data access requests by referring to the extra time period measured by said measurer.

3. An access control circuit according to claim 2, wherein the one or at least two data access requests accepted by said acceptor are equivalent to a data access request to a memory adopting a burst access system, and said calculator executes a calculating process by further referring to an overhead and a burst length of an access operation performed according to a data access request to be noticed.

4. An access control circuit according to claim 1, further comprising an access processer which executes a data access process performed according to the data access request acknowledged by each of said first acknowledger and said second acknowledger.

5. An access control circuit according to claim 4, wherein said determiner further includes a detector which detects an accepting state of said acceptor when the data access process performed by said access processor is interrupted.

6. A data processing device, comprising an access control circuit according to claim 1.
